(19) United States
(12) Patent Application Publication
(10) Pub. No.: US 2008/0030996 A1
(43) Pub. Date: Feb. 7, 2008

(54) Reptile lamp having direction adjustable function

(76) Inventor: Ming-Chih Chen, Ying Ke Chen (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/500,142

(22) Filed: Aug. 7, 2006

(51) Int. Cl. F21V 15/00

(52) U.S. Cl. 362/362

(57) ABSTRACT

A reptile lamp includes a support bracket, and at least one angle adjustable device. The angle adjustable device includes a pivot ring pivotally mounted on the support bracket, a socket pivotally mounted in the pivot ring, and an electric bulb mounted on the socket to move therewith. Thus, the electric bulb is rotatable relative to the support bracket in a two-directional way so as to adjust the angle and direction of the electric bulb freely, thereby enhancing the light effect of the electric bulb. In addition, the user only needs to operate the control knob to control the direction of the electric bulb, so that the direction of the electric bulb is controlled easily and quickly, thereby facilitating the user manipulating the control knob.

### BACKGROUND OF THE INVENTION

1. Field of the Invention

The present invention relates to a reptile lamp, and more particularly to a reptile lamp for a pet cage to project a light onto the reptile on the body of the pet in the pet cage.

2. Description of the Related Art

A conventional reptile lamp for a pet cage comprises a lamp shade, and an electric bulb mounted in the lamp shade. Thus, the electric bulb emits a light which is projected onto the reptile on the body of the pet in the pet cage. However, the electric bulb is fixed in the lamp shade and cannot be turned to change its orientation, so that the light emitted from the electric bulb is directed toward a constant direction and cannot be projected onto the whole body of the pet in the pet cage, thereby limiting the function of the reptile lamp.

### BRIEF SUMMARY OF THE INVENTION

In accordance with the present invention, there is provided a reptile lamp, comprising a support bracket, and at least one angle adjustable device mounted on the support bracket and including a pivot ring pivotally mounted on the support bracket, a socket pivotally mounted in the pivot ring, and an electric bulb mounted on the socket to move therewith.

The primary objective of the present invention is to provide a reptile lamp having a two-dimensional angle and direction adjustable function.

Another objective of the present invention is to provide a reptile lamp, wherein the electric bulb is rotatable relative to the support bracket in a two-directional way so as to adjust the angle and direction of the electric bulb freely, thereby enhancing the light effect of the electric bulb.

A further objective of the present invention is to provide a reptile lamp, wherein the user only needs to operate the control knob to control the direction of the electric bulb, so that the direction of the electric bulb is controlled easily and quickly, thereby facilitating the user manipulating the control knob.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a reptile lamp in accordance with the preferred embodiment of the present invention.

FIG. 2 is an exploded perspective view of the reptile lamp as shown in FIG. 1.

FIG. 3 is a front plan cross-sectional view of the reptile lamp as shown in FIG. 1.

FIG. 4 is a side plan cross-sectional view of the reptile lamp as shown in FIG. 1.

FIG. 5 is a bottom perspective operational view of the reptile lamp as shown in FIG. 1.

FIG. 6 is a bottom perspective operational view of the reptile lamp as shown in FIG. 1.

FIG. 7 is a perspective view of a reptile lamp in accordance with another preferred embodiment of the present invention.

### DETAILED DESCRIPTION OF THE INVENTION

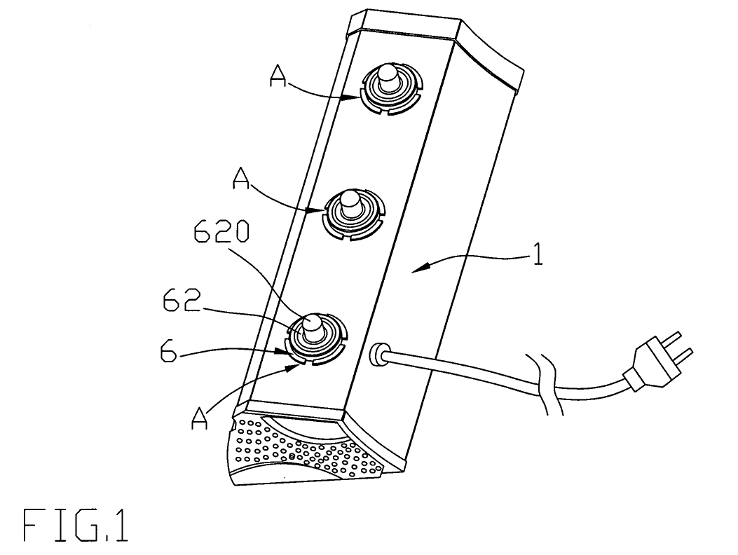

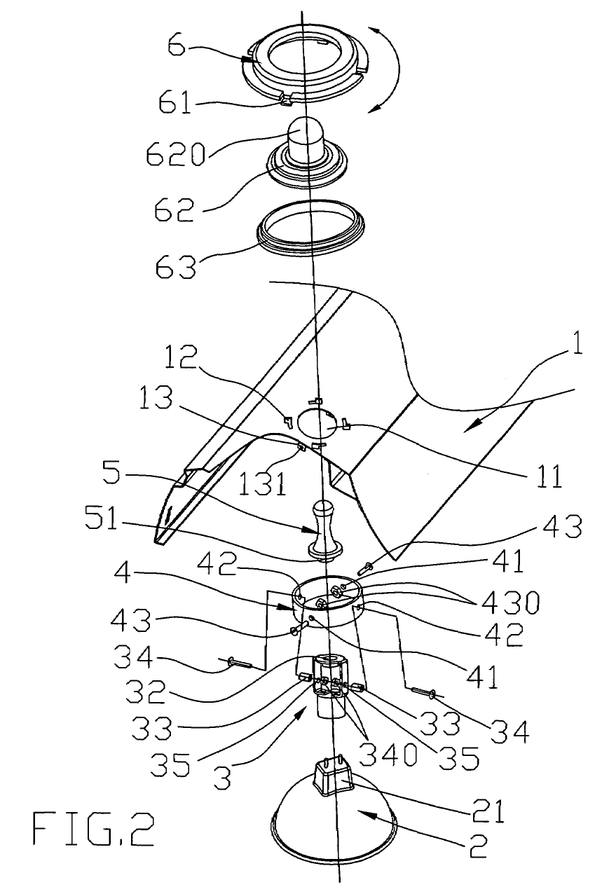

Referring to the drawings and initially to FIGS. 1-4, a reptile lamp in accordance with the preferred embodiment of the present invention comprises a support bracket 1, and at least one angle adjustable device “A” mounted on the support bracket 1.

The support bracket 1 has an elongated shape and has a substantially inverted U-shaped cross-sectional profile. The support bracket 1 has a top wall having an inner face provided with two support plates 13 each formed with a through holes 131. The top wall of the support bracket 1 is formed with a passage 11 and a plurality of locking slots 12 surrounding the passage 11.

The angle adjustable device “A” includes a pivot ring 4 pivotally mounted on the support bracket 1, a socket 3 pivotally mounted in the pivot ring 4, an electric bulb 2 mounted on the socket 3 to move therewith, a control knob 5 secured on the socket 3 to drive the socket 3 and the pivot ring 4 and partially protruded outwardly from the support bracket 1, a sleeve 62 mounted on the control knob 5, and a retainer 6 mounted on the support bracket 1 and rested on the sleeve 62 to retain the sleeve 62 on the support bracket 1.

The pivot ring 4 is pivotally mounted between the support plates 13 of the support bracket 1 and has a peripheral wall formed with two opposite through holes 41 and two opposite through bores 42.

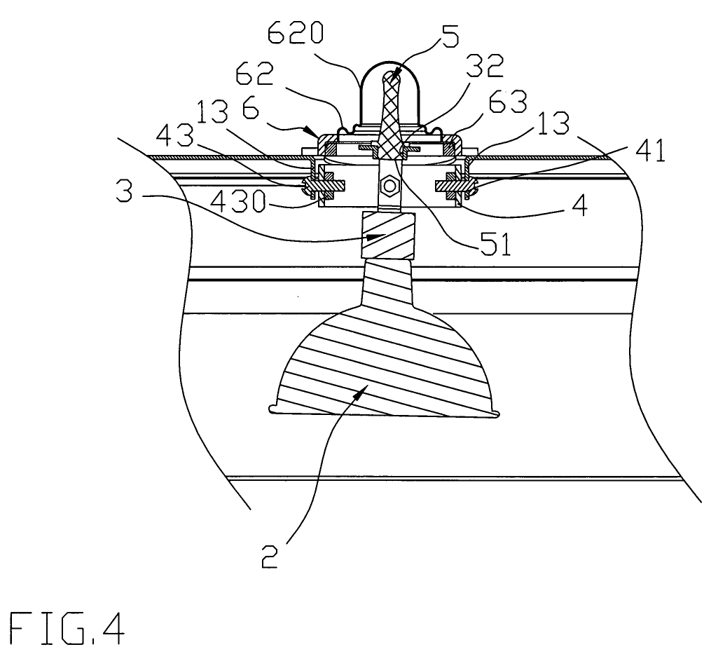

The angle adjustable device “A” further includes two screws 43 each extended through the respective through hole 131 of the support plates 13 of the support bracket 1 and the respective through hole 41 of the pivot ring 4, and two nuts 430 each screwed onto the respective screw 43 and each rested on an inner wall of the pivot ring 4, so that the pivot ring 4 is pivotally mounted between the support plates 13 of the support bracket 1 as shown in FIG. 4.

The socket 3 has an upper end formed with a locking hole 32, a mediate portion formed with two opposite through bores 35 and a lower end formed with two spaced limit pieces 31. The socket 3 and the pivot ring 4 are rotatable in a two different directions.

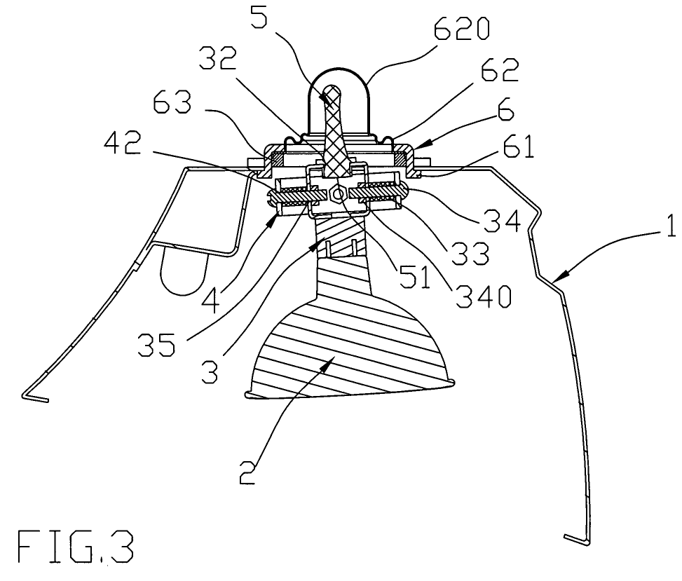

The angle adjustable device “A” further includes two screws 34 each extended through the respective through bore 42 of the pivot ring 4 and the respective through bore 35 of the socket 3, two nuts 340 each screwed onto the respective screw 34 and each rested on an inner wall of the socket 3, so that the socket 3 is pivotally mounted in the pivot ring 4 as shown in FIG. 3, and two tubular washers 33 each mounted on the respective screw 34 and each located between the socket 3 and the pivot ring 4.

The electric bulb 2 is entirely hidden in the support bracket 1. The electric bulb 2 has a base 21 detachably engaged with the lower end of the socket 3 and supported by the limit pieces 31 of the socket 3. Thus, an electric power is supplied from the socket 3 into the electric bulb 2 when the base 21 of the electric bulb 2 is attached to the socket 3, so that the electric bulb 2 emits light outwardly to project the reptile on the body of the pet in the pet cage.

The control knob 5 has a lower end formed with a locking portion 51 inserted into and locked in the locking hole 32 of the socket 3 and an upper end protruded outwardly from the passage 11 of the support bracket 1 and the retainer 6.

The sleeve 62 has a sleeve head 620 enclosed around the upper end of the control knob 5 and protruded outwardly from the support bracket 1 and the retainer 6.

The retainer 6 has a peripheral wall provided with a plurality of locking hooks 61 that are inserted into and detachably locked in the respective locking slot 12 of the support bracket 1 by rotation of the retainer 6, so that the retainer 6 is detachably secured to the support bracket 1.

The angle adjustable device “A” further includes a press ring 63 mounted in an inner wall of the retainer 6 and rested on a bottom of the sleeve 62 so that the sleeve 62 is sandwiched between the press ring 63 and the retainer 6.

In operation, referring to FIGS. 1-6, the pivot ring 4 is pivotally mounted between the support plates 13 of the support bracket 1 by the two screws 43 as shown in FIG. 4, so that the pivot ring 4 is rotatable relative to the support bracket 1 by support of the two screws 43. In addition, the socket 3 is pivotally mounted in the pivot ring 4 by the two screws 34 as shown in FIG. 3, so that the socket 3 is rotatable relative to the pivot ring 4 by support of the two screws 34. Thus, the pivot ring 4 is rotatable relative to the support bracket 1, and the socket 3 is rotatable relative to the pivot ring 4, so that the electric bulb 2 is rotatable relative to the support bracket 1 in a two-directional way so as to adjust the angle and direction of the electric bulb 2.

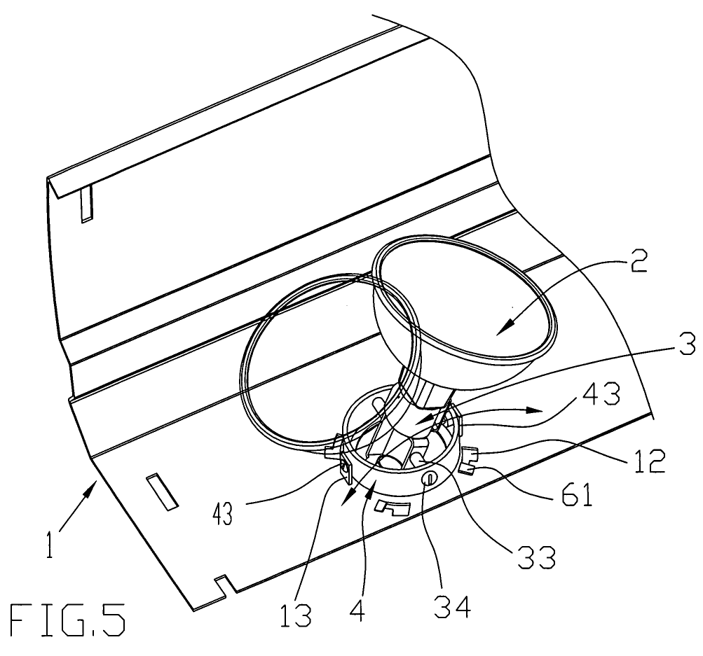

As shown in FIG. 5, the socket 3 is rotatable relative to the pivot ring 4 by support of the two screws 34, so that the electric bulb 2 is rotatable relative to the support bracket 1 in the longitudinal direction of the support bracket 1.

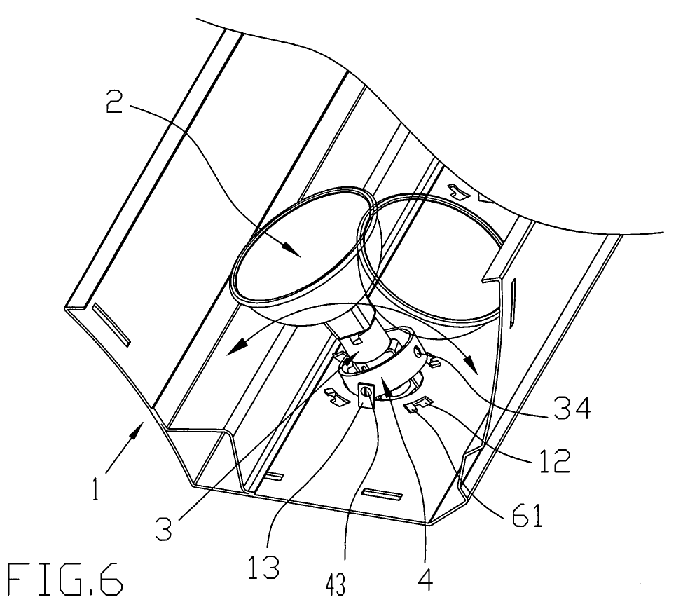

As shown in FIG. 6, the pivot ring 4 is rotatable relative to the support bracket 1 by support of the two screws 43, so that the electric bulb 2 is rotatable relative to the support bracket 1 in the transverse direction of the support bracket 1.

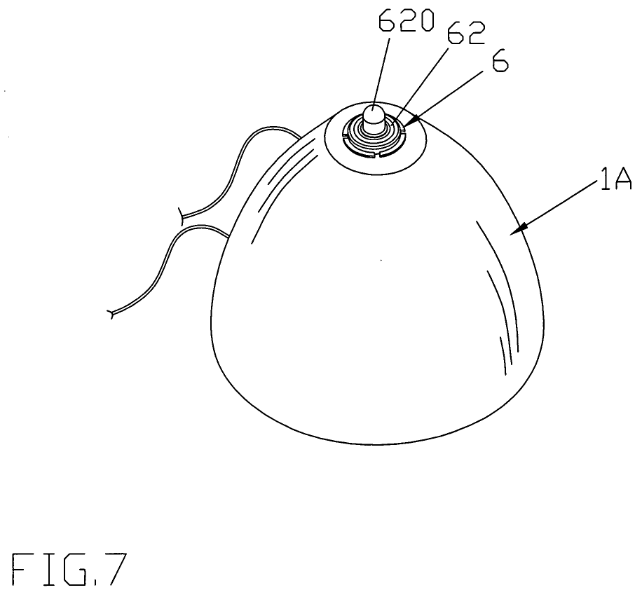

As shown in FIG. 7, the support bracket 1A has a substantially semi-spherical shape.

Accordingly, the electric bulb 2 is rotatable relative to the support bracket 1 in a two-directional way so as to adjust the angle and direction of the electric bulb 2 freely, thereby enhancing the light effect of the electric bulb 2. In addition, the user only needs to operate the control knob 5 to control the direction of the electric bulb 2, so that the direction of the electric bulb 2 is controlled easily and quickly, thereby facilitating the user manipulating the control knob 5.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A reptile lamp, comprising:
a support bracket;
at least one angle adjustable device mounted on the support bracket and including a pivot ring pivotally mounted on the support bracket, a socket pivotally mounted in the pivot ring, and an electric bulb mounted on the socket to move therewith.

2. The reptile lamp in accordance with claim 1, wherein the support bracket has a top wall having an inner face provided with two support plates, and the pivot ring is pivotally mounted between the support plates of the support bracket.

3. The reptile lamp in accordance with claim 2, wherein each of the support plates of the support bracket is formed with a through holes, the pivot ring has a peripheral wall formed with two opposite through holes, and the angle adjustable device further includes two screws each extended through the respective through hole of the support plates of the support bracket and the respective through hole of the pivot ring, and two nuts each screwed onto the respective screw and each rested on an inner wall of the pivot ring, so that the pivot ring is pivotally mounted between the support plates of the support bracket by the two screws.

4. The reptile lamp in accordance with claim 1, wherein the socket and the pivot ring are rotatable in a two different directions.

5. The reptile lamp in accordance with claim 1, wherein the pivot ring has a peripheral wall formed with two opposite through bores, the socket has a mediate portion formed with two opposite through bores, and the angle adjustable device further includes two screws each extended through the respective through bore of the pivot ring and the respective through bore of the socket, and two nuts each screwed onto the respective screw and each rested on an inner wall of the socket, so that the socket is pivotally mounted in the pivot ring by the two screws.

6. The reptile lamp in accordance with claim 5, wherein the angle adjustable device further includes two tubular washers each mounted on the respective screw and each located between the socket and the pivot ring.

7. The reptile lamp in accordance with claim 1, wherein the electric bulb is entirely hidden in the support bracket.

8. The reptile lamp in accordance with claim 1, wherein the socket has a lower end formed with two spaced limit pieces, and the electric bulb has a base detachably engaged with the lower end of the socket and supported by the limit pieces of the socket.

9. The reptile lamp in accordance with claim 1, wherein the angle adjustable device further includes a control knob secured on the socket to drive the socket and the pivot ring and partially protruded outwardly from the support bracket.

10. The reptile lamp in accordance with claim 9, wherein the socket has an upper end formed with a locking hole, the control knob has a lower end formed with a locking portion inserted into and locked in the locking hole of the socket.

11. The reptile lamp in accordance with claim 9, wherein the support bracket has a top wall formed with a passage, and the control knob has an upper end protruded outwardly from the passage of the support bracket.

12. The reptile lamp in accordance with claim 1 1, wherein the angle adjustable device further includes a sleeve mounted on the control knob, and a retainer mounted on the support bracket and rested on the sleeve to retain the sleeve on the support bracket.

13. The reptile lamp in accordance with claim 12, wherein the control knob has an upper end protruded outwardly from the retainer.

14. The reptile lamp in accordance with claim 12, wherein the top wall of the support bracket is formed with a plurality of locking slots surrounding the passage, and the retainer has a peripheral wall provided with a plurality of locking hooks that are inserted into and detachably locked in the respective locking slot of the support bracket by rotation of the retainer, so that the retainer is detachably secured to the support bracket.

15. The reptile lamp in accordance with claim 12, wherein the sleeve has a sleeve head enclosed around an upper end of the control knob and protruded outwardly from the support bracket and the retainer.

16. The reptile lamp in accordance with claim 12, wherein the angle adjustable device further includes a press ring mounted in an inner wall of the retainer and rested on a bottom of the sleeve so that the sleeve is sandwiched between the press ring and the retainer.

17. The reptile lamp in accordance with claim 1, wherein the pivot ring is rotatable relative to the support bracket, and the socket is rotatable relative to the pivot ring, so that the electric bulb is rotatable relative to the support bracket in a two-directional way.

18. The reptile lamp in accordance with claim 1, wherein the support bracket has an elongated shape and has a substantially inverted U-shaped cross-sectional profile.
